(19) United States
(12) Patent Application Publication
(10) Pub. No.: US 2011/0186363 A1
(43) Pub. Date: Aug. 4, 2011

(54) All-Terrain Vehicle and Method of Increasing Passability Thereof

(76) Inventors: Mikhail V. Ivankov, Dubna (RU); Maksim M. Ivankov, Dubna (RU)

(21) Appl. No.: 12/958,090

(22) Filed: Dec. 1, 2010

(30) Foreign Application Priority Data
Dec. 3, 2009 (RU) 2009144752

(51) Int. Cl. B62D 55/02; B23P 17/00

(52) U.S. Cl. 180/9.1; 29/401.1

(57) ABSTRACT

The invention relates to the automotive technique. The use of the present invention for increasing the cross-country ability all-terrain vehicle allows for obtaining technical result in the form of simplifying the all-terrain vehicle structure and increasing the reliability. For this purpose, the all-terrain vehicle comprises: an engine transmission section; at least one pair of supporting wheels mounted in the bottom part of the engine-transmission section at each of side faces thereof; driving wheels for number of the supporting wheels, the driving wheels being mounted on one side of each of the supporting wheels; a pair of caterpillar drives each one encircling the respective of the supporting wheels along with the driving wheel mounted on one side from the supporting wheel; a driver configured for transmitting a torsion torque from the engine-transmission section to the driving wheels. Thereby, the tension of each of the caterpillar drives is ensured for forming the pseudo-wheel having a great diameter using this caterpillar drive.

### CROSS-REFERENCE TO RELATED APPLICATIONS

This Application claims priority to Russian application RU 2009144752 filed on Dec. 3, 2009, which is incorporated herein by reference in its entirety.

### FIELD OF THE INVENTION

This invention relates to the automotive technique, and more particularly, to the method for increasing the cross-country ability all-terrain vehicle and to corresponding all-terrain vehicle.

### BACKGROUND OF THE INVENTION

At present, various methods for increasing the cross-country ability of all-terrain vehicles are known.

Known is the method for increasing the cross-country ability, disclosed in the RU 2124449 C1 (publ. on 01.10.1999). This method uses propulsion devices in the form of rhomb which diagonal lengths can vary ensuring a sui generis “walking” effect. The disadvantage of this technical solution consists in structural complexity.

Also known is the method for increasing the cross-country ability of all-terrain vehicle, disclosed in the RU 2325299 C1 (publ. on 05.27.2008), which uses an elastic 3D tyre as the propulsion device. The disadvantage of this technical solution consists also in structural complexity, since a great size of such a propulsion device comparable to the size of the all-terrain vehicle itself requires special measures for hardening the tyre surface, as well as a complex structure of the driver.

Also known is the method for increasing the cross-country ability of all-terrain vehicle, which method uses inflatable tracks encircling the wheels (see, e.g., the RU 2189321, publ. on 09.20.2002, and RU 2040426, publ. on 07.25.1995). The disadvantage of these technical solutions consists in the necessity for ensuring the inflation of the tracks, which requires again a sufficiently complex structure. Moreover, the inflatable tracks are vulnerable while operating off-the-road.

### SUMMARY OF THE INVENTION

The present invention is directed at overcoming the indicated disadvantages of the known technical solutions and ensures the achievement of the technical result in the form of simplifying the all-terrain vehicle structure and increasing the reliability.

For this purpose, the first object of the present invention provides a method for increasing the cross-country ability of all-terrain vehicle comprising an engine-transmission section and at least one pair of supporting wheels at each of side faces of the engine-transmission section, the method including steps of: mounting a driving wheel on one side of each of the supporting wheels; encircling, with a caterpillar drive, each of the supporting wheels along with the driving wheel mounted on one side thereof; ensuring a torsion torque transfer from the engine-transmission section to the driving wheels; ensuring a tension of each of the caterpillar drives for forming with the aid thereof a pseudo-wheel having a great diameter.

An additional feature of the method is in that rubber-cord tracks could be used as the caterpillar drives.

One more additional feature of the method is in that pneumatic wheels could be used as the supporting wheels. In this case, the pneumatic wheels could have the diameter not less than 1 m.

One more additional feature of the method is in that the tension of the caterpillar drives could be provided by means of mounting an idler wheel on the other side from the respective supporting wheel with reference to the driving wheel. Alternatively, the tension of the caterpillar drives could be provided by means of inflating suitably each of the pneumatic wheels.

One more additional feature of the method is in that a trailer car could be provided with at least a pair of the pseudo-wheels having a great diameter, and this trailer car could be joined with the all-terrain vehicle with the capability for deviating the trailer car from the driving direction of the all-terrain vehicle in order for ensuring a joint turn thereof. In this case, the trailer car could be joined with the all-terrain vehicle by means of the transmission from the engine-transmission section of said all-terrain vehicle.

One more additional feature of the method is in that the all-terrain vehicle could be provided with at least a pair of controlled wheels. Herewith, the controlled wheels are mounted at an independent suspension or at a car drive-axle. In the latter case, the car drive-axle could be coupled with the engine-transmission section of the all-terrain vehicle by means of a transmission.

In order for achieving the same technical result, the second object of the present invention provides an all-terrain vehicle comprising: an engine transmission section; at least one pair of supporting wheels mounted in the bottom part of the engine-transmission section at each of side faces thereof; driving wheels for number of the supporting wheels, the driving wheels being mounted on one side of each of the supporting wheels; a pair of caterpillar drives each one encircling the respective of the supporting wheels along with the driving wheel mounted on one side from the supporting wheel; a driver configured for transmitting a torsion torque from the engine-transmission section to the driving wheels.

An additional feature of the all-terrain vehicle is in that the caterpillar drives could be made in the form of rubber-cord tracks.

One more additional feature of the all-terrain vehicle is in that pneumatic wheels could be used as the supporting wheels. In this case, the pneumatic wheels could have the diameter not less than 1 m.

One more additional feature of the all-terrain vehicle is in that the all-terrain vehicle comprises further idler wheels for the number of the supporting wheels, each idler wheel being mounted on the other side from the respective supporting wheel with reference to the driving wheel, and tensioners each of which being intended for tensing the respective caterpillar drive by corresponding idler wheel in order for forming a pseudo-wheel having a great diameter using this caterpillar drive. Alternatively, the pseudo-wheels could be configured for tensing the caterpillar drives by means of inflating each of the pneumatic wheels.

One more additional feature of the all-terrain vehicle is in that the all-terrain vehicle could comprise further a trailer car provided with at least a pair of the pseudo-wheels having a great diameter, and this trailer car could be joined with the all-terrain vehicle with the capability for deviating the trailer car from the driving direction of the all-terrain vehicle in order for ensuring a joint turn thereof. In this case, the trailer car could be joined with the all-terrain vehicle by means of the transmission from the engine-transmission section of said all-terrain vehicle.

One more additional feature of the all-terrain vehicle is in that the all-terrain vehicle could comprise at least a pair of controlled wheels. Herewith, the controlled wheels could be mounted at an independent suspension or at a car drive-axle. In the latter case, the car drive-axle could be coupled with the engine-transmission section of the all-terrain vehicle by means of a transmission.

### BRIEF DESCRIPTION OF THE DRAWINGS

The invention is illustrated with reference to the drawings in which the same elements are designated by the same reference numbers.

FIG. 1 shows the side elevation view of the chassis of the all-terrain vehicle of the present invention, in which vehicle is implemented the method for increasing the cross-country ability according to the present invention.

FIG. 2 shows the front elevation view of the chassis of the all-terrain vehicle shown in

FIG. 1.

FIG. 3 shows the all-terrain vehicle and trailer car with the chassis shown in FIG. 1.

FIG. 4 shows the all-terrain vehicle having the chassis shown in FIG. 1 and controlled wheels.

### DETAILED DESCRIPTION OF EMBODIMENTS OF THE INVENTION

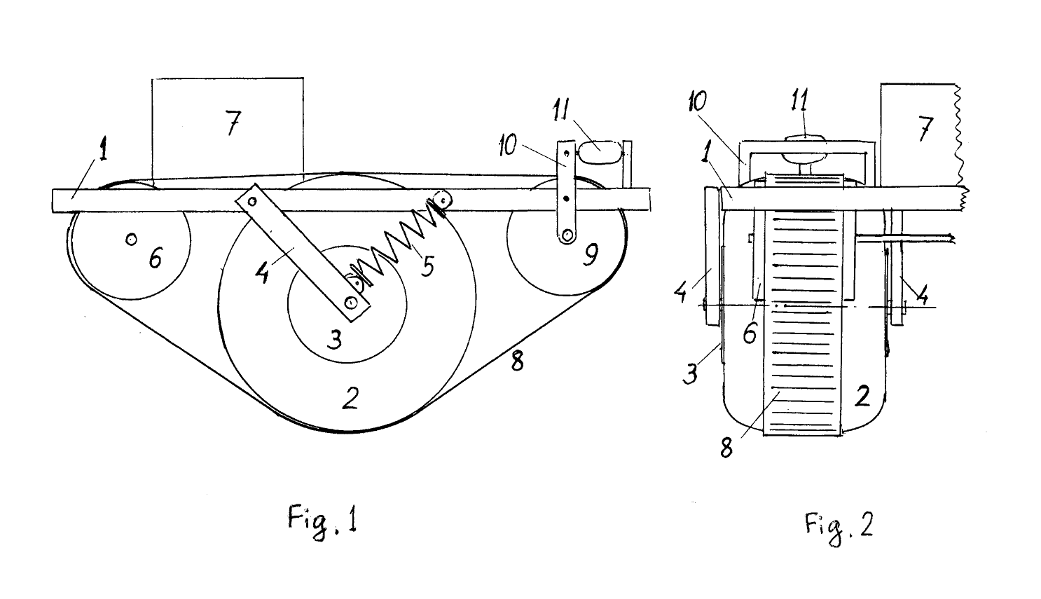

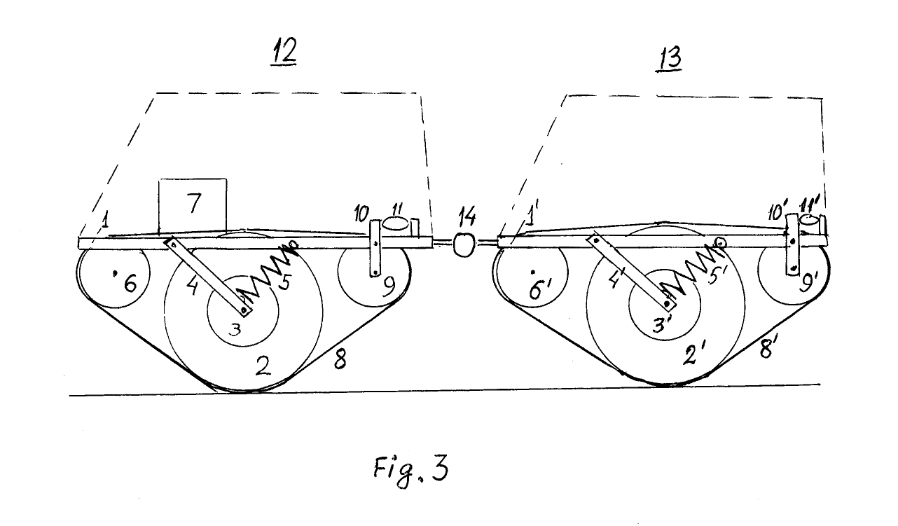

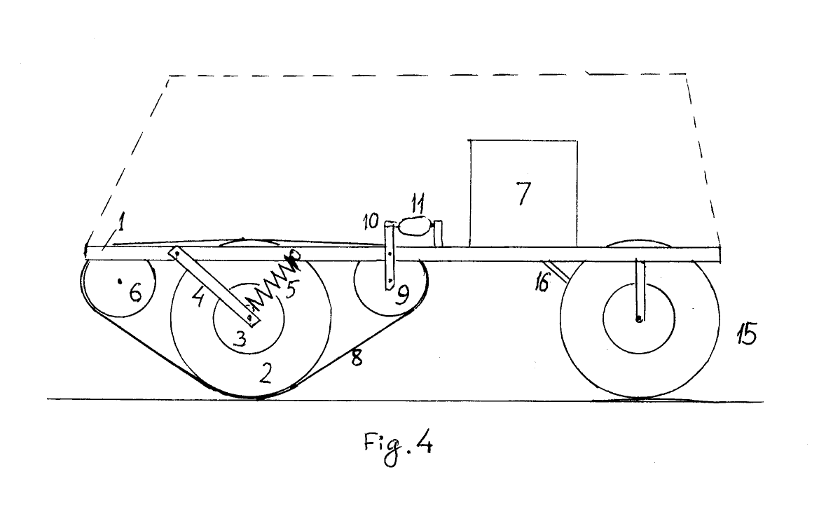

FIGS. 1 and 2 show, respectively the side elevation view and the front elevation view of the chassis of the all-terrain vehicle according to the present invention. This chassis comprises a carrying frame 1, at which each one of the side faces (with reference to the driving direction) is mounted a supporting wheel 2. As the supporting wheels, it is preferable to use pneumatic wheels, specifically pneumatic wheels having extra-low pressure tyres which diameter could exceed 1 m. However, the supporting wheels 2 could be wheels of other types. The additional benefit of utilizing the pneumatic wheels as the supporting wheels 2 is in a capability for providing a considerably greater clearance of the all-terrain vehicle by means of suspending each of them using a hub assembly 3 mounted with its one end at a lever 4 which is fixed pivotally at the carrying frame 1 and provided at the other end with a shock damper 5 (e.g., a coil spring one).

The pneumatic wheels are generally mounted at a hollow barrel flanges having motorcar hubs at each side or a central axle on conical bearings. Comparative data for this case are summarized in the following Table where the clearance amount being assumed to be equal to 0.75 from the diameter of the employed wheels.

| | | All-terrain vehicle |
|---|---|---|
| Wheel size, mm | Wheel volume, m³ | clearance, mm |
| 1100 × 500 | 0.45 | 825 |
| 1320 × 600 | 0.8 | 990 |
| 1450 × 600 | 1.0 | 1080 |
| 1700 × 500 | 1.35 | 1275 |

A driving wheel 6 is mounted at each side face of the carrying frame 1 at one side from the supporting wheel 2 (from the left in FIG. 1). Both driving wheels 6 can be fixed on a single axle which is coupled by a respective driver (e.g., by a cardan shaft) to an engine-transmission section 7 of the all-terrain vehicle. Alternatively, each driving wheel 6 can have an independent suspension and, in so doing, be coupled by a respective driver (e.g., by a chain transmission) to the engine-transmission section 7 of the all-terrain vehicle. In the latter case, each driving wheel 6 could be set in motion with its own engine-transmission section 7. The engine-transmission section 7 (or all engine-transmission section 7) is fixed on the carrying frame 1 or another base mounted rigidly to the carrying frame 1. the engine-transmission section 7 has, as is clear from its name, a motor (engine) of any type, for example, internal combustion, diesel, electric, etc., and a driver to at least one axle for transmitting rotation from the engine. It is obvious for the person skilled in the art that the engine-transmission section 7 can be enclosed into the car body having a driver's cab.

The supporting wheel 2 and the driving wheel 6 at each side face of the all-terrain vehicle are surrounded with a caterpillar drive 8, as which a rubber-cord track is preferable to use. However, the caterpillar drive type can be any other known in the art.

On the other side from the supporting wheel 2 (from the right in FIG. 1), an idler wheel 9 is mounted. This idler wheel 9 is mounted with a capability of free rotation at one end of a lever 10 of a tensioner fixed pivotally at its middle part on the carrying frame 1 and provided at its other end with a tension means 11. As such a tension means 11, it is possible to utilize a pneumatic cushion, spring, and any other means ensuring a deviation of the upper (in FIG. 1) end of the lever 10. The purpose of the tensioner (10-11) consists in ensuring the tension of the caterpillar drive 8 using the idler wheel 9 during the motion of the all-terrain vehicle, thus compensating the deviations of the lever 4 and changes in geometry of the supporting wheel 2.

The use of the above-described tensioner is not obligatory, since, in the case of performing the supporting wheels 2 in the form of pneumatic wheels, the tension of the caterpillar drive 8 can be ensured by means of inflating properly each pneumatic wheel.

Thus, the caterpillar drive 8 encircling the supporting wheel 2, driving wheel 6 and, optionally, idler wheel 9 makes a pseudo-wheel having a diameter exceeding considerably the diameter of the supporting wheel 2.

The drives of the all-terrain vehicle can be exhausted by the chassis shown in FIGS. 1 and 2. In this case, a trailer car shown in FIG. 3 is added to the all-terrain vehicle for the stable motion. The all-terrain vehicle is shown in FIG. 3 as designated by the reference number 12 as a whole, and the trailer car is shown as designated by the reference number 13. This trailer car 13 can have the same chassis as the all-terrain vehicle 12, or other chassis, for example, a pair of free-rotating wheels. In the embodiment shown in FIG. 3, an engagement assembly 14 can be configured for transmitting the torsion torque to the driving wheels 6′ of the trailer car 13 by any means known to persons skilled in the art (e.g., using a cardan shaft). Such a joint of the trailer car 13 with the all-terrain vehicle 12 ensures a capability for deviating the trailer car 13 from the driving direction of the all-terrain vehicle 12 in order for providing the joint turn thereof.

The stable motion of the all-terrain vehicle 12 can be ensured even in the absence of the trailer car. For this purpose, as is shown in FIG. 4, the chassis of the all-terrain vehicle is supplemented with controlled wheels 15. As such controlled wheels 15 can be utilized common car wheels or pneumatic wheels having a great diameter, which is particularly advantageous, if the supporting wheels 2 are also made in the form of the pneumatic wheels having a great diameter. Just such a case is illustrated in FIG. 4. Each of the controlled wheels 15 can be installed at an independent suspension, or both controlled wheels 15 can be mounted at a car drive-axle. In the latter case, the car drive-axle could be coupled with the engine-transmission section 7 of said all-terrain vehicle by means of transmission 16 which can be configured in any form (e.g., in the form of cardan shaft or chain transmission). Such controlled wheels 15 with the driver from the engine-transmission section 7 can ensure additional propulsion to the all-terrain vehicle, and in the case of making the controlled wheels in the form of the pneumatic wheels additional buoyancy as well.

The present invention ensures the claimed technical result in the form of simplifying the all-terrain vehicle structure and increasing the reliability by means of that, in the chassis of the all-terrain vehicle, a division of the suspension of the supporting wheels 2 and the driver to the supporting wheels 2 is used. By means of this, the suspension of the supporting wheels 2 can be simplified without reliability loss, since it is not necessary fro proving the driver to the supporting wheels 2, which driver must, especially in the case of the pneumatic wheels, include a sufficiently high-powered transmission for transmitting the required torsion torque to the supporting wheels setting in motion the caterpillar drive, as it occurs in the known technical solutions where the caterpillar is set in motion by means of rotating the supporting wheel. Instead of this, in the all-terrain vehicle according to the present invention, the driver from the engine-transmission section 7 to the caterpillar drive is carried out by driving wheels 6. If the driving wheels 6 are made in the from of a gear-wheels and mounted at a common car drive-axle, instead of car wheels, the diameter of these driving wheels could be decreased, thus increasing the operational reliability by means of transmitting a lesser torsion torque to the caterpillar drive. Moreover, such configuration allows to simplify the transmission of the motion from the driving wheels 6 to the caterpillar drive 8, especially when the latter is made in the form of the rubber-cord track.

The chassis in the form of the pseudo-wheel having a great radius, proposed in the present invention, ensures the increase of the all-terrain vehicle passability for the following reasons. The less is the density of the ground on which the all-terrain vehicle having such pseudo-wheels moves, the more portion of each pseudo-wheel contacts this ground, and the less is the pressure of the all-terrain vehicle onto the ground due to the more area of contact with the ground. A coefficient of traction between the pseudo-wheel with the ground increases herewith, since, in general, the underlying layers of the support surface are more dense the overlying layers.

The preferred use of the commercially available rubber-cord tracks having a width less than the width of the pneumatic wheel ensures the simplicity for holding the caterpillar drives on the surface of the supporting wheels by frictional engagement between elements of a pneumatic wheel tyre thread and the rubber-cord track. This advantage increases in the case of employing the tensioners with the dynamic compensation of the deformation of the pneumatic wheels. The use of the pneumatic wheels having the individual suspension, as mentioned above, increases the clearance of the all-terrain vehicle and ensures the buoyancy thereof.

The present invention is described and illustrated by means of the its embodiments which are not limiting. The scope of the present invention is defined only by the following claims taking into account the equivalents thereof.

1. A method for increasing the cross-country ability of all-terrain vehicle comprising an engine-transmission section and at least one pair of supporting wheels at each of side faces of the engine-transmission section, the method in-cluding steps of:
mounting a driving wheel on one side of each of the supporting wheels;
encircling, with a caterpillar drive, each of the supporting wheels along with the driving wheel mounted on one side thereof;
ensuring a torsion torque transfer from the engine-transmission section to the driving wheels; and
ensuring a tension of each of the caterpillar drives for forming with the aid thereof a pseudo-wheel having a great diameter.

2. The method according to claim 1, wherein rubber-cord track is used as said caterpillar drive.

3. The method according to claim 1, wherein pneumatic wheels are used as said supporting wheels.

4. The method according to claim 3, wherein said pneumatic wheels have the diameter not less than 1 m.

5. The method according to claim 1, wherein said tension of the caterpillar drives is provided by means of mounting an idler wheel on the other side from the respective supporting wheel with reference to said driving wheel.

6. The method according to claim 3, wherein said tension of the ca-terpillar drives is provided by means of inflating suitably each of said pneumatic wheels.

7. The method according to claim 1, wherein a trailer car is provided with at least a pair of said pseudo-wheels having a great diame-ter, and this trailer car is joined with said all-terrain vehicle with the capability for deviating said trailer car from the driving direction of said all-terrain vehicle in order for ensuring a joint turn thereof.

8. The method according to claim 7, wherein the trailer car is joined with said all-terrain vehicle by means of the transmission from said engine-transmission section of said all-terrain vehicle.

9. The method according to claim 1, wherein said all-terrain vehicle is provided with at least a pair of controlled wheels.

10. The method according to claim 9, wherein said controlled wheels are mounted at an independent suspension.

11. The method according to claim 9, wherein said controlled wheels are mounted at a car drive-axle.

12. The method according to claim 11, wherein said car drive-axle is coupled with said engine-transmission section of said all-terrain vehicle by means of a transmission.

13. An all-terrain vehicle comprising:
an engine transmission section;
at least one pair of supporting wheels mounted in the bottom part of said engine-transmission section at each of side faces thereof;
driving wheels for number of said supporting wheels, said driving wheels being mounted on one side of each of said supporting wheels;
a pair of caterpillar drives each one encircling the respective of said supporting wheels along with said driving wheel mounted on one side from said supporting wheel; and
a driver configured for transmitting a torsion torque from said engine-transmission section to said driving wheels.

14. The all-terrain vehicle according to claim 13, wherein said caterpillar drives are made in the form of rubber-cord tracks.

15. The all-terrain vehicle according to claim 13, wherein pneumatic wheels are uses as said supporting wheels.

16. The all-terrain vehicle according to claim 15, wherein said pneumatic wheels have the diameter not less than 1 m.

17. The all-terrain vehicle according to claim 13, wherein the all-terrain vehicle comprises further:
idler wheels for the number of said supporting wheels, each of said idler wheels being mounted on the other side from the respective supporting wheel with reference to said driving wheel; and
tensioners each of which being intended for tensing the respective of said caterpillar drives by the corresponding idler wheel in order for forming a pseudo-wheel having a great diameter using this caterpillar drive.

18. The all-terrain vehicle according to claim 15, wherein said pseu-do-wheels are configured for tensing said caterpillar drives by means of inflating each of the pneumatic wheels.

19. The all-terrain vehicle according to any of claim 13, comprising further a trailer car provided with at least a pair of said pseudo-wheels having a great diameter, and said trailer car is joined with said all-terrain vehicle with the capability for deviating said trailer car from the driving direction of said all-terrain vehicle in order for ensuring a joint turn thereof.

20. The all-terrain vehicle according to claim 19, wherein the trailer car is joined with said all-terrain vehicle by means of the transmission from said en-gine-transmission section of said all-terrain vehicle.

21. The all-terrain vehicle according to any of claim 13, comprising further at least a pair of controlled wheels.

22. The all-terrain vehicle according to claim 21, wherein said controlled wheels are mounted at an independent suspension.

23. The all-terrain vehicle according to claim 21, wherein said controlled wheels are mounted at a car drive-axle.

24. The all-terrain vehicle according to claim 23, wherein said car drive-axle is coupled with said engine-transmission section of said all-terrain vehicle by means of a transmission.
